(19) United States
(12) Patent Application Publication
(10) Pub. No.: US 2026/0031682 A1
(43) Pub. Date: Jan. 29, 2026

(54) DEVICE FOR CONDUCTING COOLING AIR ON A MOTOR MOUNT FOR A FAN MOTOR

(71) Applicant: HANON SYSTEMS EFP DEUTSCHLAND GMBH, Bad Homburg v.d. Höhe (DE)

(72) Inventors: Anand Sivaram Sivaramakrishnan, Griesheim (DE); Romualdo Vivace, Rüsselsheim (DE)

(21) Appl. No.: 18/849,759

(22) PCT Filed: Aug. 3, 2023
(86) PCT No.: PCT/DE2023/100572

§ 371 Date: Apr. 1, 2025

(30) Foreign Application Priority Data
Sep. 19, 2022 (DE) 10 2022 123 882.2

(51) Int. Cl. H02K 9/10; F04D 29/54; F04D 29/58

(52) U.S. Cl. CPC H02K 9/10; F04D 29/541; F04D 29/5806

(57) ABSTRACT

A device for conducting cooling air on a motor mount for a fan motor, in particular an electric fan motor or a fan-cooled motor. The device has multiple recesses extending on an end of the ring-shaped motor mount from the outer circumference of the ring-shaped motor mount to the inner circumference of the ring-shaped motor mount, to conduct some of an air flow generated by the fan at the outer circumference of the ring-shaped motor mount to the ring aperture cross-section.

CROSS REFERENCE TO RELATED PATENT APPLICATIONS

This is a U.S. national phase patent application of PCT/DE2023/100572 filed Aug. 3, 2023, which claims the benefit of and priority to German Patent Application No. 10 2022 123 882.2, filed on Sep. 19, 2022, the entire contents of each of which are incorporated herein by reference for all purposes.

### TECHNICAL FIELD

The invention relates to a device for conducting cooling air on a motor mount for a fan motor, in particular an electric fan motor or a fan-cooled motor, in order to achieve an improved cooling performance. The invention also relates to a ring-shaped motor mount on which a corresponding device is formed.

### BACKGROUND ART

Electric motors operate very effectively owing to their high efficiency of more than 90 per cent. However, some of the supplied electrical energy is converted during operation into heat, which must be dissipated as continuously as possible to avoid overheating. To this end, the motor housings of electric motors have heat sinks in the form of cooling fins, which are usually arranged on the outer circumference, forming outwardly open flow channels for cooling air, in order to achieve an increase in surface area for heat dissipation to an ambient medium. The motor housings have a usually streamlined, cylindrical shape, which is delimited by two opposing ends. In air-cooled electric motors, the cooling performance can be assisted by ducted cooling with a fan driven by the electric motor or an end impeller. The rotation of the fan or of the end impeller causes an air flow to be generated, some of which is conducted along the cooling fins of the motor housing through the flow channels formed by the cooling fins. The heat generated by the electric motor can thus be dissipated via the motor housing using the air flow generated by the fan or the end impeller.

However, cooling by means of the generated air flow proves difficult at the ends of the motor housing, because the air flow is guided substantially along the outer circumference of the motor housing, and at least one end of the motor housing is covered by a motor mount to which the motor housing is fastened. It is also disadvantageous that a flow along the cooling fins is unfavorably influenced by the full-faced fastening of an end of the motor housing to such a motor mount, because the air inlets and air outlets of flow channels formed between the cooling fins of the motor housing are likewise covered by the motor mount. For this reason, motor mounts, in particular for fan motors, can be ring-shaped, so that, when the electric motor is fastened at the end, at least some of the end face of the electric motor remains free and thus accessible to a cooling air flow in the region of the ring aperture cross-section of the motor mount. The dimensions of the ring-shaped motor mount are advantageously selected such that they cover the smallest possible area of the end of the electric motor or of the electric motor housing, and thus air inlets or air outlets of flow channels formed between the cooling fins remain at least partially free.

Expediently, such ring-shaped motor mounts for fan motors in particular in vehicle fans, as are used for example for engine cooling or for air-conditioning of the vehicle interior, are formed inside a flow-permeable holding structure. Gratings or spokes are used as holding structures, so as to influence the air flow generated by the fan as little as possible.

It has been found that the cooling performance on the end face side of a motor housing fastened at the end is insufficient at this end despite the ring-shaped design of the motor housing mount, because an air flow in the region of the ring aperture cross-section of the ring-shaped motor mount is low.

### SUMMARY

The invention is therefore based on the object of providing a device with which the end cooling performance of a fan motor or fan-cooled electric motor fastened at the end to a motor mount can be improved.

The object is achieved by a device having the features as shown and described herein.

To achieve the object, a device for conducting cooling air on a ring-shaped motor mount for a fan motor is proposed. The invention is intended in particular for fan motors which have outwardly extending cooling fins on their motor housing outer side in an arrangement, which, between the cooling fins, form outwardly open channels for cooling air, the cooling air inlets of which channels are oriented towards an end of the motor housing of the fan motor. The device according to the invention specifies a motor mount in a ring shape, to which the motor housing of the fan motor can be fastened by an end of the motor housing, wherein a ring aperture cross-section of the ring-shaped motor mount is dimensioned such that the cooling air inlets of the channels for cooling air are situated at least partially within the ring aperture cross-section. The device has multiple recesses extending on an end of the ring-shaped motor mount from the outer circumference of the ring-shaped motor mount to the inner circumference of the ring-shaped motor mount, to conduct some of an air flow generated by the fan at the outer circumference of the ring-shaped motor mount to the ring aperture cross-section. The recesses are preferably distributed uniformly.

Advantageously, the recesses in the end face at the end of the ring-shaped motor mount form, at the end face of the ring-shaped motor mount, air-conducting elements in the form of outwardly open air-conducting channels, which are geometrically designed such that they conduct an air flow, generated by the fan by the rotation thereof at the outer circumference of the ring-shaped motor mount, along the recesses from the outer circumference of the ring-shaped motor mount to the inner circumference of the ring-shaped motor mount, that is, to the ring aperture cross-section, so that the supplied cooling air can pass from the ring aperture cross-section through the cooling air inlets into the channels for cooling air of the motor housing. In this way, an improved utilization of the cooling air flow can be achieved and the cooling performance at the end can be improved. The recesses are depressions which, according to one embodiment, are formed in the end face of the ring-shaped motor mount substantially in the axial direction of the fan motor fastened at the end to the ring-shaped motor mount. The recesses on the radial outer circumference of the ring-shaped motor mount have openings which can also be referred to as air inlet openings, wherein openings of the recesses which can also be referred to as air outlet openings are formed on the radial inner circumference of the ring-shaped motor mount. The air inlet openings and the air outlet openings are each connected to one another by a recess, wherein a flow path for cooling air is formed between an air inlet opening and an air outlet opening along the recess connecting the openings. The flow path of the cooling air is defined by the course of the recess, wherein the length of the flow path is defined by the geometric shape of the recess. The recesses can also be referred to as air-conducting elements or air-conducting channels.

The ring aperture cross-section of the ring-shaped motor mount is preferably circular. However, designs of the ring-shaped motor mount can also be provided in which the ring aperture cross-section has a different shape, which is adapted to the geometric shape of the end face of the motor housing.

Fan motors within the meaning of the invention include motors which are fastened by an end to a motor mount and directly drive an axial impeller or an end impeller and thus generate an air flow.

Within the meaning of the invention, a motor housing has a cylindrical shape which is delimited by two opposing ends and on the lateral face of which the cooling fins with outwardly open cooling channels are formed. The motor housing is provided for fastening by an end to the ring-shaped motor mount.

The geometric design of the recesses can be provided such that a length of the course of each recess from the outer circumference to the inner circumference of the ring-shaped motor mount is greater than the radial distance between the outer circumference and the inner circumference of the ring-shaped motor mount. This means that the recesses preferably do not extend in a straight line on the shortest way from the outer circumference to the inner circumference of the ring-shaped motor mount but are bent or diagonal or follow a curve of the end face. In other words, the flow paths of the recesses are longer than the radial thickness of the ring-shaped motor mount.

The course of the recesses can also reproduce a specific curved path in the form of a predefined trajectory. The recesses can thus follow a predefined trajectory from the outer circumference of the ring-shaped motor mount to the inner circumference of the ring-shaped motor mount. The courses of the multiple recesses from the outer circumference to the inner circumference of the ring-shaped motor mount can be identical. However, it can also be provided for the recesses alternately to follow the course of different trajectories or reproduce the course of different trajectories.

The courses of the recesses are oriented in the fan rotation direction. Accordingly, the courses of the recesses can be oriented in the clockwise direction when the fan rotates clockwise, wherein an axial air flow which is sucked in from the end of the ring-shaped motor mount is generated by the blades of the fan.

According to a further embodiment of the device according to the invention, the recesses can be in the form of spiral rays, the origin of which is situated in the center point of the ring-shaped motor mount.

In all the embodiments of the recesses formed in the ring-shaped motor mount, it can be provided for the recesses to have depressions formed transversely to their course in the form of grooves. These depressions have an influence on the flow of the cooling air along the air-conducting channels formed by the recesses. Preferably, the depressions are formed transversely to the course of the recesses in the form of grooves.

Preferably, the grooves can be formed in the course of the recesses in the direction of the inner circumference of the ring-shaped motor mount in the last quarter, preferably in the last fifth, of the flow path.

Advantageously, the recesses can be rounded at the transition to the end face of the end of the ring-shaped motor mount. A specific radius can be predefined, which depends on the dimensioning of the device as a whole.

Furthermore, the radial transitions at the outer circumference and at the inner circumference of the ring-shaped motor mount can be rounded.

It can also be provided for the recesses to have a constriction along their course in the cooling air flow direction. Advantageously, an acceleration of the cooling air flow in the direction of the ring aperture cross-section is achieved by the constriction in the course of the recesses, as a result of which the flow speed along the channels for cooling air on the motor housing is ultimately accelerated.

According to a particularly preferred embodiment of the device according to the invention, the recesses are arranged such that they each open into a cooling air inlet between two cooling fins of the motor housing on the inner circumference of the ring-shaped motor mount. This ensures that the cooling air guided along the recesses passes directly through a radial cooling air outlet into a channel for cooling air formed by two cooling fins. Expediently, the number of recesses formed in the end of the ring-shaped motor mount can correspond to the number of channels for cooling air on the motor housing.

According to one embodiment, the recesses can each have the same depth and the same width, wherein the depth and the width of the recesses are dimensioned depending on the motor size.

The ring-shaped motor mount of the device according to the invention can have holes through which screws are screwed into the motor housing of the fan motor in order to fasten the fan motor to the ring-shaped motor mount. Preferably, the ring-shaped motor mount has at least three holes for the screw-fastening of the fan motor housing. Further fastening types are conceivable, for example a clamp fastening, wherein a clamp connection is formed between a flange formed by the ring-shaped motor mount and a flange formed on the motor housing.

According to a further advantageous embodiment of the device according to the invention, an end face of the ring-shaped motor mount on which the recesses are formed can be curved, preferably convexly curved. In this case, it can be provided for the courses of the recesses to follow the curve with their flow paths. In this embodiment, the depth of the recesses is the same at every position along their course in relation to the curved end face of the ring-shaped motor mount.

Also part of the invention is a ring-shaped motor mount which has the device according to the invention according to one or more of the above embodiments. This includes a ring-shaped motor mount on the end of which recesses are formed to conduct cooling air. The ring-shaped motor mount can have different ring shapes. The ring shape of the motor mount is not limited to a circular ring shape.

The ring-shaped motor mount can be designed as a part of a holding structure with low air resistance. The holding structure with low air resistance is preferably a grating or spoke structure in the center of which the ring-shaped motor mount is formed.

### DESCRIPTION OF DRAWINGS

Further details, features and advantages of embodiments of the invention can be found in the description of exemplary embodiments below with reference to the associated drawings. In the drawings:

FIG. 1: shows a schematic diagram of a ring-shaped motor mount known from the prior art for receiving and holding a fan motor,

FIG. 2: shows a ring-shaped motor mount for a fan motor in conjunction with a flat holding structure,

FIG. 3: shows a detail diagram of an exemplary embodiment of the device according to the invention for conducting cooling air on the ring-shaped motor mount for a fan motor,

FIG. 4: shows a further detail of the device according to the invention for conducting cooling air on the ring-shaped motor mount for a fan motor, and

FIG. 5: shows a schematic diagram of a further exemplary embodiment of the device according to the invention for conducting cooling air on a motor mount for a fan motor.

### DESCRIPTION OF AN EMBODIMENT

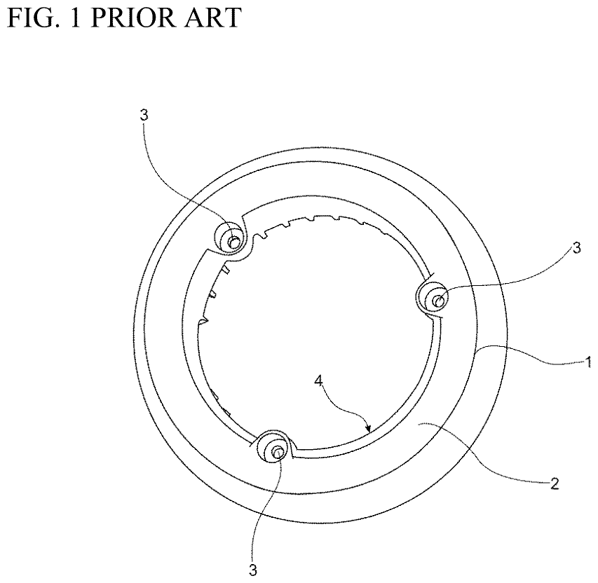

FIG. 1 shows a schematic diagram of a ring-shaped motor mount 1 known from the prior art for receiving and holding a fan motor. The end 2 of the ring-shaped motor mount 1 is smooth and curved slightly outwards, that is, convexly curved. The fan motor is fastened by means of screws (not shown), which are fed through the holes 3 formed in the ring-shaped motor mount 1 and screwed into an end of the fan motor housing. The holes 3 are formed as moldings in the material of the ring-shaped motor mount 1 and are distributed uniformly on the inner circumference 4 of the ring-shaped motor mount 1. From the end 2, the holes 3 have countersunk holes in order to countersink the screw heads in the installed state. The fan motor is fastened to the rear of the ring-shaped motor mount 1, that is, on the end of the ring-shaped motor mount 1 opposite the end 2.

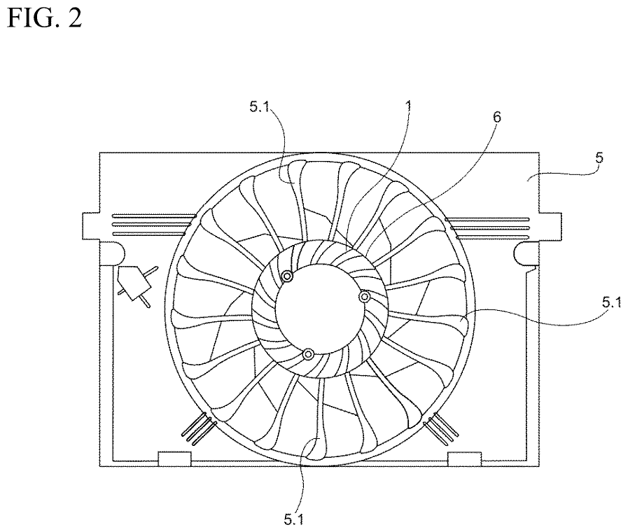

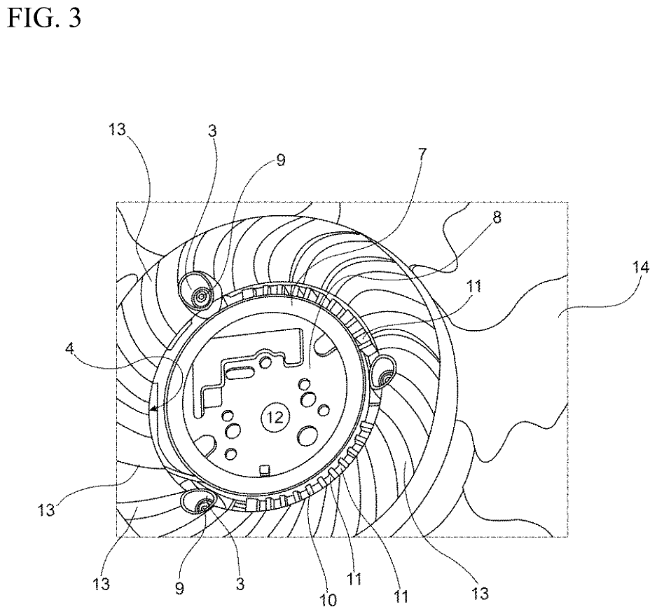

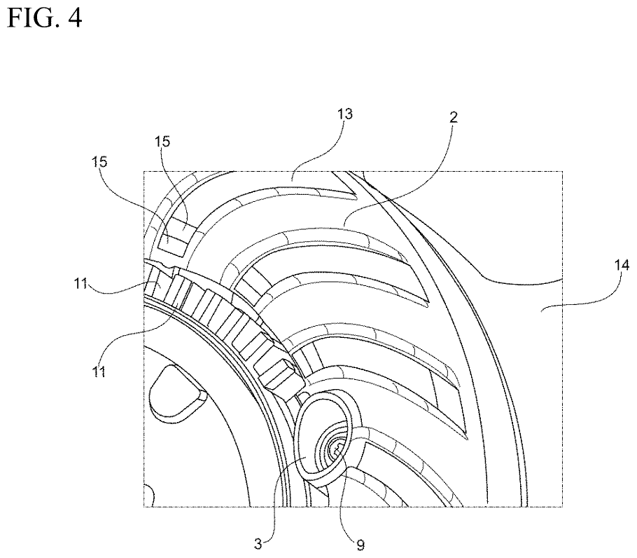

FIG. 2 shows a ring-shaped motor mount 1 for a fan motor in conjunction with a flat holding structure 5, as can be used in a vehicle, for example. FIG. 2 serves to illustrate the location of the ring-shaped motor mount 1 inside the holding structure 5. In the example shown, the ring-shaped motor mount 1 is arranged in the center of the holding structure 5, held by radial spokes 5.1 of the holding structure 5. The radial spokes 5.1 are fastened to the outer circumference 6 of the ring-shaped motor mount 1. In this way, the ring-shaped motor mount 1 can receive a fan motor in order to generate an air flow orthogonally to the holding structure 5. The embodiment of the ring-shaped motor mount shown in FIG. 2 comprises the device according to the invention, which is explained in more detail in conjunction with the fan motor in FIGS. 3 and 4.

FIG. 3 shows a detail diagram of an exemplary embodiment of the device according to the invention for conducting cooling air on the ring-shaped motor mount 1 for a fan motor 7, which is fastened by an end 8 to the rear of the ring-shaped motor mount 1. The fastening means used are screws 9, which are fed through the holes 3 and screwed into the fan motor housing. The fan motor 7 has outwardly extending cooling fins 10 on its motor housing outer side in an arrangement which, between the cooling fins 10, forms outwardly open channels for cooling air, the cooling air inlets 11 of which channels are oriented towards an end of the motor housing. The ring-shaped motor mount 1 has a ring aperture cross-section 12 which is delimited by the inner circumference 4 and is dimensioned such that cooling air inlets 11 of the channels for cooling air of the fan motor 7 are situated at least partially inside the ring aperture cross-section 12. The device according to the invention has multiple recesses 13 extending on the end 2 of the ring-shaped motor mount 1 from the outer circumference 6 of the ring-shaped motor mount 1 to the inner circumference 4 of the ring-shaped motor mount 1. The recesses 13 are used to conduct some of an air flow generated by the fan 14 at the outer circumference 6 of the ring-shaped motor mount 1 towards the ring aperture cross-section 12.

FIG. 4 shows a detail of the ring-shaped motor mount 1 shown in FIGS. 2 and 3, on which the device according to the invention is formed. According to the invention, the ring-shaped motor mount 1 is dimensioned in relation to the size of the fan motor housing such that the cooling air inlets 11 are situated within the ring aperture cross-section 12 of the ring-shaped motor mount 1. According to the invention, the recesses 13 which are formed on the end 2 and are designed in the form of depressions in the end face of the end 2 to conduct air extend from the outer circumference 6 of the ring-shaped motor mount 1 to the inner circumference 4 of the ring-shaped motor mount 1, wherein the recesses 13 are uniformly distributed. An arrangement of the recesses 13 or a positioning of the ring-shaped motor mount 1 and of the fan motor 7 can be provided in which the recesses 13 open into the cooling air inlets 11 on the inner circumference 4, so that air conducted through the recesses 13 can pass directly into the cooling air inlets 11. The course of the recesses 13 is designed corresponding to the rotation direction of the fan 14. The courses of the recesses are not straight but follow a curved path, resulting in an arcuate course. The rotation direction of the fan 14 generates an air flow, which is sucked in to the end 2 of the ring-shaped motor mount 1 on which the recesses 13 are formed. Owing to the arrangement and orientation of the recesses 13, at least some of the air sucked in by the fan 14 during operation is conducted in the direction of the ring aperture cross-section 12, so that sucked-in air can be conducted through the cooling air inlets 11 into the channels for cooling air of the fan motor 7. An improvement in the cooling air flow axially to the motor housing of the fan motor 7 is thus produced, and an improved cooling performance is also achieved at the end 8 of the fan motor 7.

The recesses 13 have depressions which are designed in the form of grooves 15

transversely to the course of the recesses 13. Furthermore, the transitions of the recesses 13 at the end 2 are rounded. The end face of the end 2 of the ring-shaped motor mount 1 is convex, that is, curved outwards, in the present exemplary embodiment. The courses of the recesses 13 follow this convex design of the end face side of the ring-shaped motor mount 1. The courses of the recesses 13 are thus likewise curved.

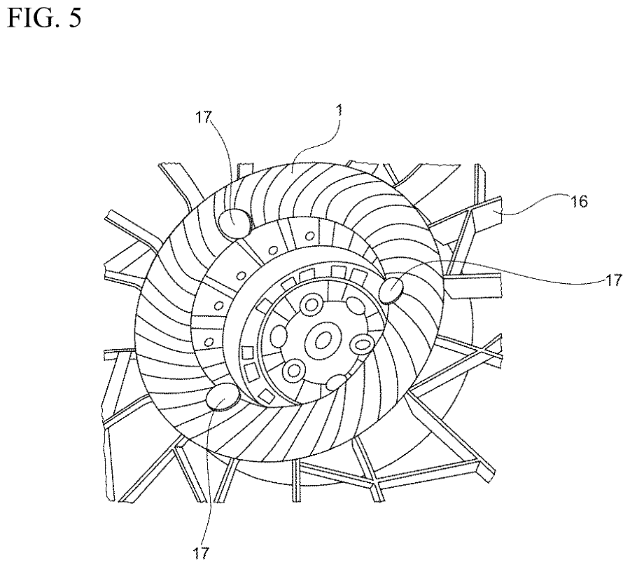

FIG. 5 shows a further exemplary embodiment of the device according to the invention for conducting cooling air on a ring-shaped motor mount 1 for a fan motor 7 (not shown), wherein the ring-shaped motor mount 1 is held in an integrated manner inside a grating structure 16, which additionally has reinforcing struts. The ring-shaped motor mount 1 has three fastening points 17, to which the fan motor 7 (not shown here) can be fastened.

The invention relates to a device for conducting cooling air on a motor mount for a fan motor, in particular an electric fan motor or a fan-cooled motor, in order to achieve an improved cooling performance. The invention also relates to a ring-shaped motor mount on which a corresponding device is formed.

1-14. (canceled)

15. A device for conducting cooling air on a ring-shaped motor mount for a fan motor, which has outwardly extending cooling fins on its motor housing outer side in an arrangement which, between the cooling fins, forms outwardly open channels for the cooling air, inlets for the cooling air of which channels are oriented towards an end of the motor housing, wherein the motor housing is fastened by the end to the ring-shaped motor mount, wherein a ring aperture cross-section of the ring-shaped motor mount is dimensioned such that the inlets for the cooling air of the channels for the cooling air are situated at least partially within the ring aperture cross-section, having multiple recesses extending on an end of the ring-shaped motor mount from an outer circumference of the ring-shaped motor mount to an inner circumference of the ring-shaped motor mount, to conduct some of an air flow generated by the fan at the outer circumference of the ring-shaped motor mount to the ring aperture cross-section.

16. The device according to claim 15, wherein a length of a course of the recesses is greater than a radial distance between the outer circumference and the inner circumference of the ring-shaped motor mount.

17. The device according to claim 15, wherein the recesses follow a predefined trajectory from the outer circumference of the ring-shaped motor mount to the inner circumference of the ring-shaped motor mount.

18. The device according to claim 15, wherein courses of the recesses are oriented in a rotation direction of the fan.

19. The device according to claim 15, wherein the recesses are in a form of spiral rays, an origin of which is situated in a center point of the ring-shaped motor mount.

20. The device according to claim 15, wherein the recesses have depressions formed transversely to their course in a form of grooves.

21. The device according to claim 20, wherein the grooves are formed in the course of the recesses in a direction of the inner circumference of the ring-shaped motor mount in a last quarter.

22. The device according to claim 15, wherein the recesses are rounded at a transition to an end face of the end of the ring-shaped motor mount.

23. The device according to claim 15, wherein the recesses each have a constriction along their course.

24. The device according to claim 15, wherein the recesses are arranged such that they each open into one of the inlets for the cooling air between two of the cooling fins of the motor housing on the inner circumference of the ring-shaped motor mount.

25. The device according to claim 15, wherein a number of the recesses corresponds to a number of the channels for the cooling air.

26. The device according to claim 15, wherein all of the recesses have a same depth and a same width.

27. The device according to claim 15, wherein an end face of the end of the ring-shaped motor mount on which the recesses are formed is curved.

28. The ring-shaped motor mount for receiving and fastening the fan motor, having the device for conducting the cooling air according to claim 15.
